(19) United States
(12) Patent Application Publication
(10) Pub. No.: US 2024/0022766 A1
(43) Pub. Date: Jan. 18, 2024

(54) METHOD AND APPARATUS FOR DYNAMIC MESH CODING

(71) Applicants: HYUNDAI MOTOR COMPANY, Seoul (KR); KIA CORPORATION, Seoul (KR); DIGITALINSIGHTS INC., Seoul (KR)

(72) Inventors: Yong Jo Ahn, Seoul (KR); Jong Seok Lee, Seoul (KR); Seung Wook Park, Yongin-si (KR)

(73) Assignees: HYUNDAI MOTOR COMPANY, Seoul (KR); KIA CORPORATION, Seoul (KR); DIGITALINSIGHTS INC., Seoul (KR)

(21) Appl. No.: 18/374,510

(22) Filed: Sep. 28, 2023

Related U.S. Application Data
(63) Continuation of application No. PCT/KR2022/004439, filed on Mar. 29, 2022.

(30) Foreign Application Priority Data
Apr. 2, 2021 (KR) 10-2021-0043654
Mar. 28, 2022 (KR) 10-2022-0038209

(51) Int. Cl. H04N 19/597; G06T 7/20; H04N 19/139; H04N 19/172; H04N 19/184; H04N 19/59

(52) U.S. Cl. CPC H04N 19/597; G06T 7/20; H04N 19/139; H04N 19/172; H04N 19/184; H04N 19/59

(57) ABSTRACT

A dynamic mesh encoding/decoding method and the apparatus use motion information present between a plurality of frames constituting a dynamic mesh in order to improve coding efficiency by removing temporal redundancy of the dynamic mesh.

### CROSS-REFERENCE TO RELATED APPLICATIONS

This application is a Continuation of International Application No. PCT/KR2022/004439 filed on Mar. 29, 2022, which claims priority to Korean Patent Application No. 10-2021-0043654 filed on Apr. 2, 2021, and Korean Patent Application No. filed on Mar. 28, 2022, the entire disclosures of which are incorporated herein by reference.

### TECHNICAL FIELD

The present disclosure relates to an apparatus and a method for dynamic mesh coding.

### BACKGROUND

The statements in this section merely provide background information related to the present disclosure and do not necessarily constitute prior art.

In general, meshes may be classified into static meshes and dynamic meshes. The static mesh means three-dimensional information at a moment, and includes mesh information in one single frame. On the other hand, the dynamic mesh means mesh information during a specific time, and includes mesh information distributed over a plurality of frames according to time changes.

In a mesh compression method of the related art, a mesh is encoded or decoded per frame basis regardless of dependence between an previous frame and a current frame. In other words, for a plurality of frames constituting the dynamic mesh, each frame is individually encoded or decoded. Therefore, a coding method and an apparatus using inter-frame dependence should be considered in encoding or decoding the dynamic mesh.

### SUMMARY

The present disclosure seeks to provide a dynamic mesh encoding/decoding method and an apparatus that additionally use motion information present between a plurality of frames constituting a dynamic mesh in order to improve coding efficiency by removing temporal redundancy of the dynamic mesh.

At least one aspect of the present disclosure provides a decoding method for decoding a dynamic mesh, performed by a dynamic mesh decoding apparatus. The decoding method includes acquiring a bitstream and then separating a first bitstream and a second bitstream from the bitstream. Here, a preset key frame among a plurality of frames representing the dynamic mesh is encoded in the first bitstream and one of the frames other than the key frame among the plurality of frames is encoded in the second bitstream. The decoding method also includes decoding the bitstream. When the bitstream is the first bitstream, decoding the bitstream includes reconstructing a mesh of the key frame by decoding the first bitstream and storing the mesh of the key frame as a immediately previous frame in a mesh storage. When the bitstream is the second bitstream, decoding the bitstream includes restoring motion data of a current frame by decoding the second bitstream reconstructing a mesh of the current frame by applying the motion data to an immediately previous frame and storing the mesh of the current frame as the immediately previous frame in the mesh storage.

Another aspect of the present disclosure provides a dynamic mesh decoding apparatus for decoding a dynamic mesh. The decoding apparatus includes a bitstream separator configured to acquire a bitstream and then separate a first bitstream and a second bitstream from the bitstream. Here, a preset key frame among a plurality of frames representing the dynamic mesh is encoded in the first bitstream and one of the frames other than the key frame among the plurality of frames is encoded in the second bitstream. The decoding apparatus also includes a mesh decoder configured to decode the first bitstream to reconstruct a mesh of the key frame when the bitstream is the first bitstream. The decoding apparatus also includes a motion decoder configured to decode the second bitstream to restore motion data of a current frame when the bitstream is the second bitstream. The decoding apparatus also includes a motion compensator configured to apply the motion data to an immediately previous frame to reconstruct a mesh of the current frame. The decoding apparatus also includes a mesh storage configured to store the mesh of the key frame and the mesh of the current frame as the immediately previous frame.

Yet another aspect of the present disclosure provides an encoding method for encoding a dynamic mesh, performed by a dynamic mesh encoding apparatus. The encoding method includes acquiring a current frame constituting the dynamic mesh and checking whether the current frame is a preset key-frame. The encoding method also includes encoding the current frame. When the current frame is the key frame, encoding the current frame includes encoding the key frame to generate a first bitstream, generating a reconstructed mesh of the key frame from the first bitstream, and storing the reconstructed mesh of the key frame as an immediately previous frame in a mesh storage. When the current frame is not the key frame, encoding the current frame includes extracting motion data using a mesh of the current frame and the reconstructed mesh of the immediately previous frame, generating a second bitstream by encoding the motion data and generating restored motion data from the second bitstream, generating a reconstructed current frame by applying the restored motion data to the immediately previous frame, and storing the reconstructed current frame as the immediately previous frame in the mesh storage.

As described above, the present disclosure provides a dynamic mesh encoding/decoding method and an apparatus that additionally use motion information present between the plurality of frames constituting the dynamic mesh. Thus, coding efficiency is improved by removing temporal redundancy of the dynamic mesh,

### BRIEF DESCRIPTION OF THE DRAWINGS

FIG. 1 is a block diagram conceptually illustrating a dynamic mesh encoding

apparatus according to an embodiment of the present disclosure.

FIG. 2 is a block diagram conceptually illustrating a dynamic mesh decoding apparatus according to an embodiment of the present disclosure.

FIG. 3 is a block diagram conceptually illustrating a dynamic mesh encoding apparatus using coordinate system transformation according to another embodiment of the present disclosure.

FIG. 4 is a block diagram conceptually illustrating a dynamic mesh decoding apparatus using coordinate system inverse transformation according to another embodiment of the present disclosure.

FIG. 5 is a block diagram conceptually illustrating a dynamic mesh encoding apparatus using coordinate system transformation according to another embodiment of the present disclosure.

FIG. 6 is a block diagram conceptually illustrating a dynamic mesh decoding apparatus using the coordinate system inverse transformation according to another embodiment of the present disclosure.

FIG. 7 is a block diagram illustrating a motion encoder in an encoding apparatus according to an embodiment of the present disclosure.

FIG. 8 is an illustrative diagram illustrating motion map generation and down-sampling according to an embodiment of the present disclosure.

FIG. 9 is a block diagram illustrating a motion decoder in the decoding apparatus according to an embodiment of the present disclosure.

FIG. 10 is a flowchart illustrating a dynamic mesh encoding method according to an embodiment of the present disclosure.

FIG. 11 is a flowchart illustrating a dynamic mesh decoding method according to an embodiment of the present disclosure.

FIG. 12 is a flowchart illustrating a dynamic mesh encoding method according to another embodiment of the present disclosure.

FIG. 13 is a flowchart illustrating a dynamic mesh decoding method according to another embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, detailed descriptions of related known components and functions, where considered to obscure the subject of the present disclosure, may have been omitted for the purpose of clarity and for brevity.

The present embodiments relate to an apparatus and a method for dynamic mesh coding. More specifically, to remove temporal redundancy of the dynamic mesh, the present disclosure provides a dynamic mesh encoding/decoding method and apparatus that additionally use motion information present between a plurality of frames constituting a dynamic mesh.

In the following description, a mesh refers to a static mesh including one frame. Thus, meshes and frames can be used interchangeably. Meanwhile, the dynamic mesh includes a plurality of frames having at least one key frame set in advance. For example, the key frame indicates a frame that does not refer to other frames when encoding or decoding is performed. Frames other than the key frame are referred to as non-key frames.

Hereinafter, motion information and the motion data may be used interchangeably. When a component, unit, device, element, or the like of the present disclosure is described as having a purpose or performing an operation, function, or the like, the component, unit, device, element, or the like should be considered herein as being “configured to” meet that purpose or to perform that operation or function. Each component, unit, device, element, and the like may separately embody or be included with a processor and a memory, such as a non-transitory computer readable media, as part of thereof.

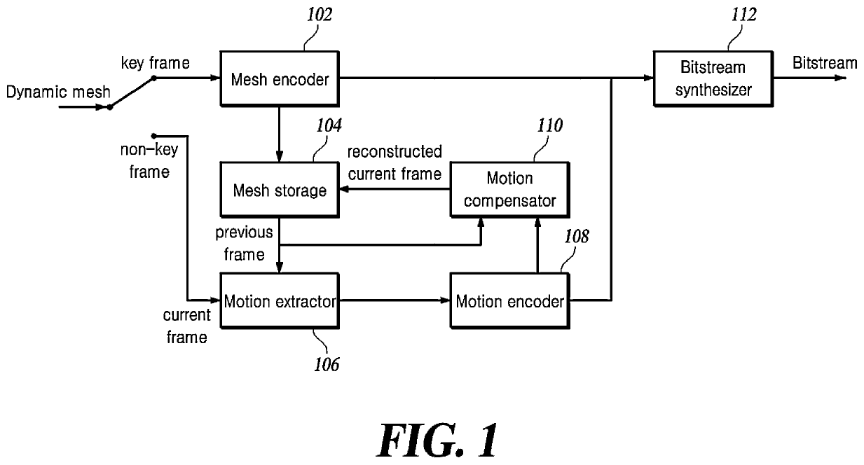

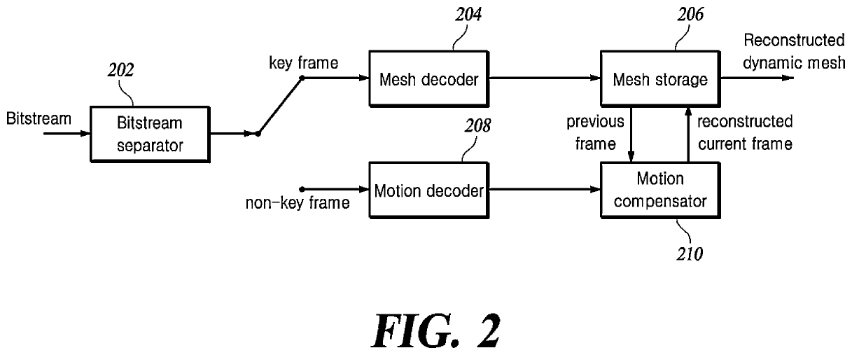

A dynamic mesh encoding apparatus that encodes a dynamic mesh (hereinafter referred to as an “encoding apparatus”) and a dynamic mesh decoding apparatus that decodes a dynamic mesh (hereinafter referred to as a “decoding apparatus”) are described below with reference to the illustration of FIGS. 1 and 2.

FIG. 1 is a block diagram conceptually illustrating a dynamic mesh encoding apparatus according to an embodiment of the present disclosure.

The encoding apparatus according to the present embodiment acquires an original dynamic mesh and then encodes the original dynamic mesh to generate a bitstream. The encoding apparatus may include all or some of a mesh encoder 102, a mesh storage 104, a motion extractor 106, a motion encoder 108, a motion compensator 110, and/or a bitstream synthesizer 112.

The encoding apparatus checks whether a current frame is a key frame with respect to frames constituting an input dynamic mesh. When the current frame is the key frame, the mesh is transferred to the mesh encoder 102. When the current frame is a non-key frame, the mesh is transferred to the motion extractor 106.

The mesh encoder 102 encodes the transferred mesh to generate a bitstream and generates a reconstructed mesh from the bitstream. The bitstream may be transferred to the bitstream synthesizer 112 and the reconstructed mesh may be stored in the mesh storage 104. To encode the mesh, the mesh encoder 102 may use an existing mesh encoding method. For example, a method of encoding each of vertices, edges, and attribute information constituting the mesh may be used. Meanwhile, the mesh encoder 102 may reconstruct the mesh before generating a final bitstream related to the mesh by using a decoding method corresponding to the encoding method so that the reconstructed mesh can be referred to by the next frame.

The mesh storage 104 stores the reconstructed mesh of the immediately previous frame. Here, the immediately previous frame may be one of a restored key frame or a restored non-key frame. When the current frame is the non-key frame, the stored mesh may be used for motion extraction of the current frame and restoration of the current frame. Accordingly, the stored mesh may be used by the motion extractor 106 and the motion compensator 110.

The motion extractor 106 extracts the motion information using the input mesh of the current frame and the reconstructed mesh of the immediately previous frame stored in the mesh storage 104. For example, the motion extractor 106 may extract the motion data for each vertex of the mesh. As another example, the motion extractor 106 may extract at least one piece of motion data for one face of the mesh. In this case, the motion data of vertices constituting one face may be interpolated so that the motion data can be extracted for interpolated points of the vertices. Accordingly, the number and resolution of the motion data may be determined according to the number and resolution of interpolation points. As another example, the motion extractor 106 may extract the motion data on a per patch including a plurality of faces and vertices. Here, the motion data of the vertices, faces, or patches may be three-dimensional motion vectors representing how the vertices, faces, or patches move. The extracted motion information may be transferred to the motion encoder 108.

The motion encoder 108 encodes the transferred motion information to generate a bitstream. The generated bitstream may be transferred to the bitstream synthesizer 112. Further, the motion encoder 108 may generate the motion information restored from the bitstream. The generated restored motion information may be transferred to the motion compensator 110. A detailed operation of the motion encoder 108 is described below.

The motion compensator 110 applies motion restoration information to the immediately previous frame stored in the mesh storage 104 to compensate for the motion. The current frame is thereby reconstructed. The reconstructed current frame may be stored in the mesh storage 104 for encoding of the next frame.

The bitstream synthesizer 112 may connect the input bitstreams to synthesize one bitstream. The encoding apparatus may store the synthesized bitstream or may transfer the combined bitstream to the decoding apparatus.

FIG. 2 is a block diagram conceptually illustrating a dynamic mesh decoding apparatus according to an embodiment of the present disclosure.

The decoding apparatus according to the present embodiment acquires the bitstream and then decodes the bitstream to reconstruct the original dynamic mesh. The decoding apparatus may include all or some of a bitstream separator 202, a mesh decoder 204, a mesh storage 206, a motion decoder 208, and/or a motion compensator 210. The bitstream separator 202 separates the bitstream on the basis of header

information of the input bitstream. The bitstream corresponding to the key frame may be transferred to the mesh decoder 204. The bitstream corresponding to the non-key frame may be transferred to the motion decoder 208.

The mesh decoder 204 decodes the bitstream corresponding to the key frame to reconstruct the mesh. The mesh decoder 204 may use a decoding method corresponding to the encoding method used by the mesh encoder 102 in the encoding apparatus to decode the mesh. The reconstructed mesh may be stored in the mesh storage 206.

The mesh storage 206 stores the reconstructed mesh of the immediately previous frame. Here, the immediately previous frame may be one of a restored key frame or a restored non-key frame. The mesh storage 206 may output the stored mesh for a display, for example. Further, when the current frame is the non-key frame, the stored mesh may be used to reconstruct the current frame. Accordingly, the stored mesh may be used by the motion compensator 210.

The motion decoder 208 decodes the bitstream corresponding to the non-key frame to restore the motion information of the current frame. The restored motion information may be transferred to the motion compensator 210. A detailed operation of the motion decoder 208 is described below.

The motion compensator 210 applies the restored motion information to the immediately previous frame stored in the mesh storage 206 to reconstruct the current frame. The reconstructed current frame may be stored in the mesh storage 206 for restoration of the next frame.

Meanwhile, a coordinate system in which there is an input dynamic mesh may not be an optimal coordinate system in terms of mesh coding efficiency. Therefore, an original coordinate system of the input mesh may be transformed into a first coordinate system suitable for mesh encoding prior to encoding. For example, the coordinate system transformation may be a transformation from an orthogonal coordinate system, which is the original coordinate system to a cylindrical coordinate system. Alternatively, the coordinate system transformation may be a transformation from the orthogonal coordinate system to a spherical coordinate system. As another example, when the original coordinate system is the cylindrical coordinate system, the coordinate system transformation may be a transformation from the cylindrical coordinate system to the orthogonal coordinate system or a transformation from the cylindrical coordinate system to the spherical coordinate system. As another example, when the original coordinate system is the spherical coordinate system, the coordinate system transformation may be a transformation from the spherical coordinate system to the orthogonal coordinate system or a transformation from the spherical coordinate system to the cylindrical coordinate system.

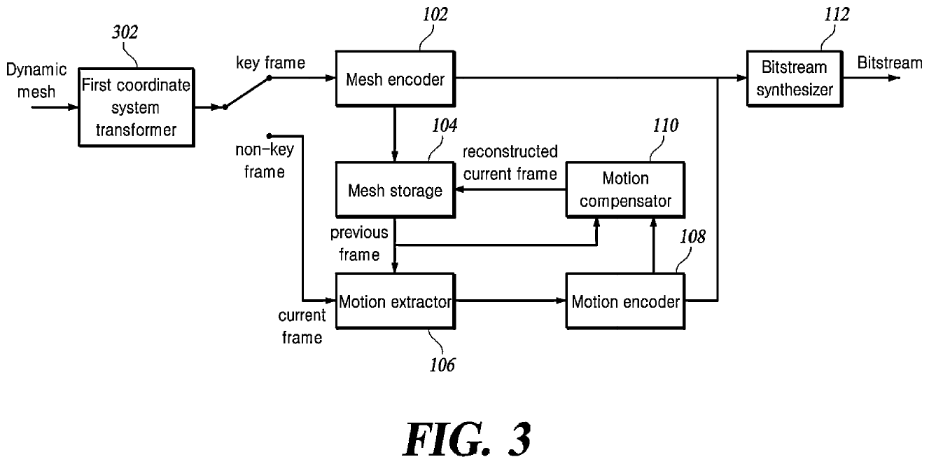

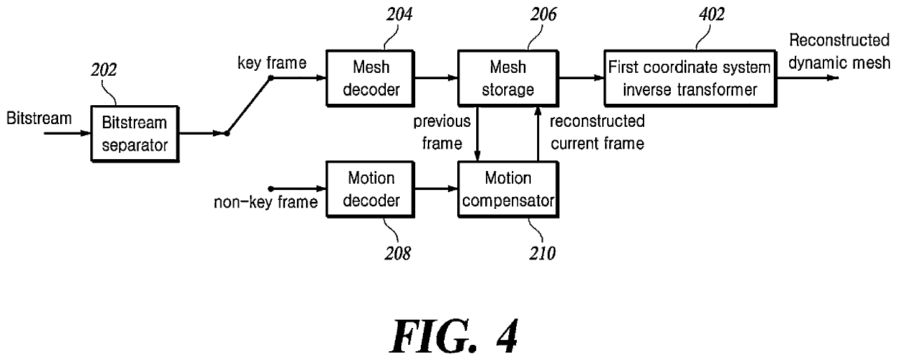

Hereinafter, an encoding apparatus and a decoding apparatus using coordinate system transformation are described using the illustrations of FIGS. 3 and 4.

FIG. 3 is a block diagram conceptually illustrating a dynamic mesh encoding apparatus using coordinate system transformation according to another embodiment of the present disclosure.

As another embodiment, the encoding apparatus may encode the dynamic mesh using coordinate system transformation. To this end, as illustrated in FIG. 3, the encoding apparatus may additionally include a first coordinate system transformer 302.

The first coordinate system transformer 302 transforms the original coordinate system into the first coordinate system with respect to the vertices of the input dynamic mesh. In this case, the encoding apparatus may transfer information related to the coordinate system transformation to the decoding apparatus in the form of a bitstream. Alternatively, a coordinate system transformation method may be shared between the encoding apparatus and the decoding apparatus using information at a high level.

Since operations of remaining components that encode the current frame of which the coordinate system has been transformed to the first coordinate system are the same as those of the encoding apparatus illustrated in FIG. 1, detailed description thereof has been omitted.

FIG. 4 is a block diagram conceptually illustrating a dynamic mesh decoding apparatus using the coordinate system inverse transformation according to another embodiment of the present disclosure.

As another embodiment, the decoding apparatus may decode the dynamic mesh using the coordinate system inverse transformation. To this end, the decoding apparatus may additionally include a first coordinate system inverse transformer 402, as illustrated in FIG. 4.

Since operations of remaining components that decode the current frame on the first coordinate system from the bitstream are the same as those of the decoding apparatus illustrated in FIG. 2, detailed description thereof has been omitted.

The first coordinate system inverse transformer 402 inversely transforms the first coordinate system of the mesh into the original coordinate system prior to output of the mesh stored in the mesh storage 206. In this case, the decoding apparatus may acquire information related to the coordinate system transformation in the form of a bitstream from the encoding apparatus. Alternatively, the decoding apparatus may perform coordinate system transformation of the reconstructed mesh using information transferred from the high level. Alternatively, the decoding apparatus can perform the coordinate system transformation of the reconstructed mesh using a new coordinate system unrelated to the original coordinate system and the first coordinate system used in the encoding apparatus.

Even when one coordinate system transformation is applied as described above, the first coordinate system may not be optimal in terms of coding efficiency in which the motion information extraction and motion compensation are considered. Therefore, the first coordinate system of the mesh may be transformed into the second coordinate system prior to the extraction of the motion information. Here, the second coordinate system may be different from the original coordinate system and the first coordinate system, and may be suitable for the motion prediction and compensation in terms of the coding efficiency.

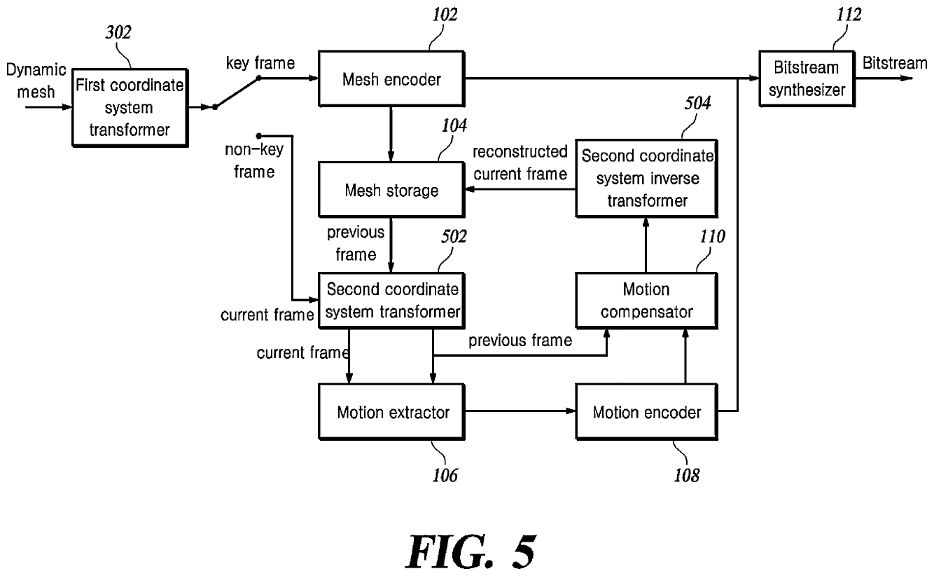

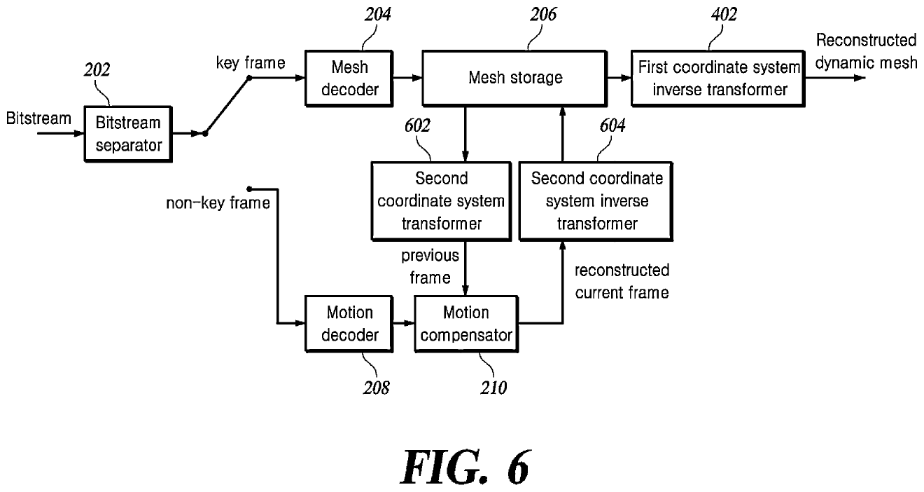

Hereinafter, an encoding apparatus and a decoding apparatus using two coordinate system transformations are described using the illustrations of FIGS. 5 and 6.

FIG. 5 is a block diagram conceptually illustrating a dynamic mesh encoding apparatus using coordinate system transformation according to another embodiment of the present disclosure.

As another embodiment, the encoding apparatus may encode the dynamic mesh using two coordinate system transformations. To this end, as illustrated in FIG. 5, the encoding apparatus may additionally include the first coordinate system transformer 302, a second coordinate system transformer 502, and a second coordinate system inverse transformer 504.

As described above, the first coordinate system transformer 302 transforms the original coordinate system into the first coordinate system for the vertices of the input dynamic mesh.

The encoding apparatus checks whether the current frame is a key frame with respect to frames of which the coordinate system has been transformed. When the current frame is the key frame, the mesh is transferred to the mesh encoder 102. When the current frame is a non-key frame, the mesh is transferred to the second coordinate system transformer 502.

The mesh encoder 102 encodes the transferred mesh to generate a bitstream. The generated bitstream may be transferred to the bitstream synthesizer 112. Further, the mesh encoder 102 may generate a reconstructed mesh from the bitstream. The reconstructed mesh may be stored in the mesh storage 104.

The mesh storage 104 stores the reconstructed mesh of the immediately previous frame. Here, the immediately previous frame may be one of a restored key frame or a restored non-key frame. When the current frame is the non-key frame, the stored mesh may be used for motion extraction of the current frame and restoration of the current frame. Therefore, the stored mesh can be used for motion extraction and motion compensation. The stored mesh may be transferred to the second coordinate system transformer 502 for coordinate system transformation prior to the use for the motion extraction and motion compensation.

The second coordinate system transformer 502 transforms the first coordinate system of the current frame corresponding to the non-key frame into the second coordinate system prior to the motion extraction and compensation. Further, the second coordinate system transformer 502 transforms the first coordinate system of the immediately previous frame stored in the mesh storage 104 into the second coordinate system. The current frame of which the coordinate system has been transformed into the second coordinate system may be transferred to the motion extractor 106. The immediately previous frame of which the coordinate system has been transformed may be transferred to the motion extractor 106 and the motion compensator 110.

The motion extractor 106 extracts the motion data using the transferred current frame and the immediately previous frame. The extracted motion information may be transferred to the motion encoder 108.

The motion encoder 108 encodes the transferred motion information to generate a bitstream. The generated bitstream may be transferred to the bitstream synthesizer 112. Further, the motion encoder 108 may generate the motion data restored from the bitstream. The generated restored motion information may be transferred to the motion compensator 110.

The motion compensator 110 applies the restored motion information to the immediately previous frame of which the coordinate system has been transformed to compensate for the motion. The current frame is thereby reconstructed. The reconstructed current frame may be transferred to the second coordinate system inverse transformer 504 for the coordinate system inverse transformation before the reconstructed current frame is stored in the mesh storage 104.

The second coordinate system inverse transformer 504 inversely transforms the second coordinate system of the reconstructed current frame into the first coordinate system. The reconstructed current frame of which the coordinate system has been inversely transformed into the first coordinate system may be stored in the mesh storage 104 for encoding of the next frame.

The bitstream synthesizer 112 may connect the input bitstreams to synthesize one bitstream. The encoding apparatus may store the synthesized bitstream or may transfer the synthesized bitstream to the decoding apparatus.

FIG. 6 is a block diagram conceptually illustrating a dynamic mesh decoding

apparatus using the coordinate inverse system transformation according to another embodiment of the present disclosure.

As another embodiment, the decoding apparatus may decode the dynamic mesh using two coordinate system inverse transformations. To this end, as illustrated in FIG. 6, the decoding apparatus may additionally include a first coordinate system inverse transformer 402, a second coordinate system transformer 602, and a second coordinate system inverse transformer 604.

The bitstream separator 202 separates the bitstream on the basis of the header information of the input bitstream. The bitstream corresponding to the key frame may be transferred to the mesh decoder 204 and the bitstream corresponding to the non-key frame may be transferred to the motion decoder 208. As described above, the bitstream is generated by the encoding apparatus on the first coordinate system and then transferred to the decoding apparatus.

The mesh decoder 204 decodes the bitstream corresponding to the key frame to reconstruct the mesh. The mesh decoder 204 may use the decoding method corresponding to the encoding method used by the mesh encoder 102 in the encoding apparatus to decode the mesh. The reconstructed mesh may be stored in the mesh storage 206.

The mesh storage 206 stores the transferred reconstructed mesh. Here, the immediately previous frame may be one of a restored key frame or a restored non-key frame. The mesh storage 206 may output the stored mesh for a display, for example, and may transfer the stored mesh to the first coordinate system inverse transformer 402 for coordinate system transformation prior to the output. Further, when the current frame is the non-key frame, the stored mesh may be used to reconstruct the current frame. Therefore, the stored mesh may be used for motion compensation and may be transferred to the second coordinate system transformer 602 for coordinate system transformation prior to the use for motion compensation.

The second coordinate system transformer 602 transforms the first coordinate system of the immediately previous frame into the second coordinate system prior to the motion compensation. The immediately previous frame of which the coordinate system has been transformed into the second coordinate system may be transferred to the motion compensator 210.

The motion decoder 208 decodes the bitstream corresponding to the non-key frame to restore the motion information of the current frame. As described above, the motion information is generated by the encoding apparatus on the second coordinate system and then transferred to the decoding apparatus. The restored motion information may be transferred to the motion compensator 210.

The motion compensator 210 applies the restored motion information to the immediately previous frame of which the coordinate system has been transformed. The current frame is thereby reconstructed. Before the reconstructed current frame is stored in the mesh storage 206, the reconstructed current frame may be transferred to the second coordinate system inverse transformer 604 for the coordinate system inverse transformation.

The second coordinate system inverse transformer 604 inversely transforms the second coordinate system of the reconstructed current frame into the first coordinate system. The reconstructed current frame of which the coordinate system has been inversely transformed into the first coordinate system may be stored in the mesh storage 206 for restoration of the next frame.

The first coordinate system inverse transformer 402 may inversely transform the coordinate system of the mesh from the first coordinate system to the original coordinate system to generate a reconstructed dynamic mesh before outputting the mesh stored in the mesh storage 206.

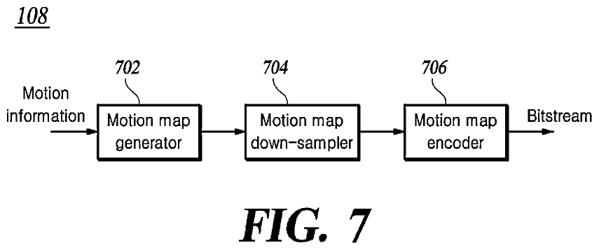

Hereinafter, operations of the motion encoder 108 and the motion decoder 208 are described using the illustrations of FIGS. 7-9.

FIG. 7 is a block diagram illustrating a motion encoder in an encoding apparatus according to an embodiment of the present disclosure.

As described above, the motion encoder 108 encodes the motion information to generate a bitstream and generates the motion information restored from the generated bitstream. In this case, the motion information may be a three-dimensional motion vector for all vertices of the mesh. Alternatively, the motion information may be a motion space for all positions in a three-dimensional space. The motion encoder 108 may include all or some of a motion map generator 702, a motion map down-sampler 704, and/or a motion map encoder 706.

The motion map generator 702 two-dimensionally maps the transferred motion information to generate one or more motion maps. The one or more generated motion maps may be transferred to the motion map down-sampler 704.

The motion map down-sampler 704 down-samples the transferred motion map to a smaller size. In this case, one of various filters having lengths such as 4-tap, 6-tap, or 8-tap may be used as a filter used for down-sampling. Alternatively, a bicubic filter and a sub-sampling filter, which are general methods, for example, may be used. The down-sampled motion map may be transferred to the motion map encoder 706.

The motion map encoder 706 encodes the transferred motion map to generate a bitstream. To encode the motion map, the motion map encoder 706 may use an existing image or video compression method. For example, a video compression method such as Joint Photographic coding Experts Group (JPEG), JPEG2000, High Efficiency Image File Format (HEIF), Portable Network Graphics (PNG), or the like may be used. Alternatively, an image compression method such as H.264/Advanced Video Coding (AVC), H.265/High Efficiency Video Coding (HEVC), H.266/Versatile Video Coding (VVC). or the like may be used. In this case, a used motion map compression method may be transferred from the encoding apparatus to the decoding apparatus with the motion map compression method encoded at the high level. According to the transferred motion map compression method, the decoding apparatus may restore the motion map using a decoding method corresponding to the encoding method used in the encoding apparatus.

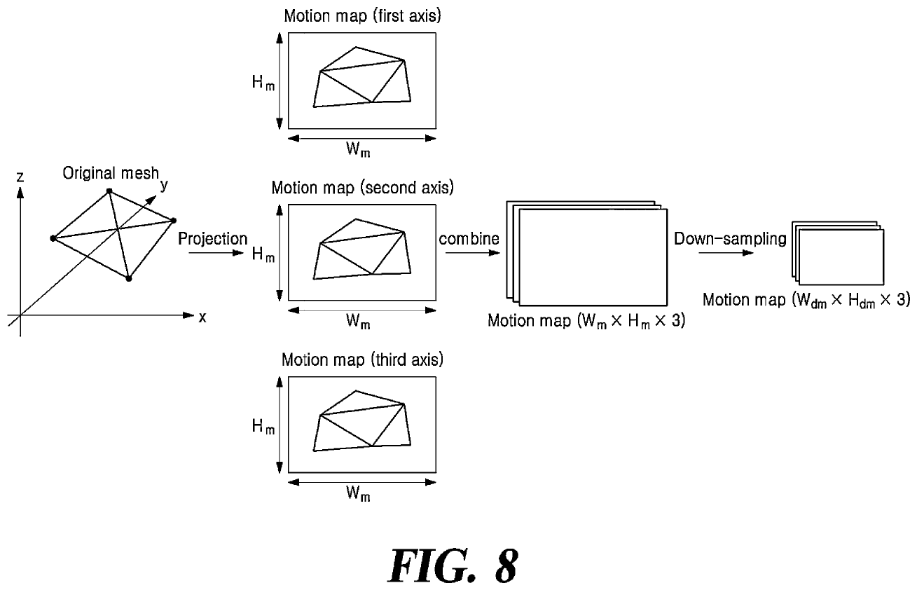

FIG. 8 is an illustrative diagram illustrating motion map generation and down-sampling according to an embodiment of the present disclosure.

Since the mesh expresses a relationship between vertices in the three-dimensional space and a texture map, the motion map corresponding to three-dimensional motion information may also have a two-dimensional map similar to the texture map. For example, the motion data extracted for each vertex of the mesh may be mapped to the motion map. As another example, the motion data of the vertices may be interpolated so that at least one piece of motion data is generated for a polygonal face of the mesh and then this motion data can be mapped to the motion map. Since the motion data may be a three-dimensional vector as described above, the motion map may be generated using magnitude values of the three-dimensional vector for each of x, y, and z axes. Thereafter, each motion map mapped to each axis may be combined in the form of an image having three channels, as in the example of FIG. 8.

Meanwhile, when the motion data is mapped to the vertices, the motion map may have a sparse characteristic. Thus, down-sampling may be performed by the motion map down-sampler 704 to improve the coding efficiency by the motion map encoder 706.

When the motion data is mapped to a face of a mesh, down-sampling can be implicitly performed in parallel in an interpolation process. Thus, an operation of the motion map down-sampler 704 can be omitted.

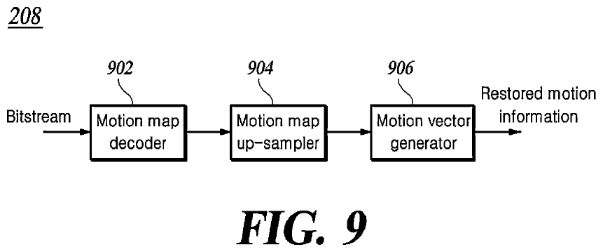

FIG. 9 is a block diagram illustrating a motion decoder in the decoding apparatus according to an embodiment of the present disclosure.

As described above, the motion decoder 208 decodes the bitstream corresponding to the non-key frame to restore the motion information of the current frame. The motion decoder 208 may include all or some of the motion map decoder 902, the motion map up-sampler 904, and/or a motion vector generator 906.

The motion map decoder 902 decodes the transferred bitstream to restore the motion map. In this case, according to the motion map compression method transferred from the high level, the decoding apparatus may restore the motion map using a decoding method corresponding to the encoding method used in the encoding apparatus. The restored motion map may be transferred to the motion map up-sampler 904.

The motion map up-sampler 904 up-samples the transferred restored motion map to restore a motion map with an original size. The up-sampled motion map may be transferred to the motion vector generator 906.

The motion vector generator 906 transforms the transferred motion map into a motion vector so that the transferred motion map can be used in a subsequent motion compensation step.

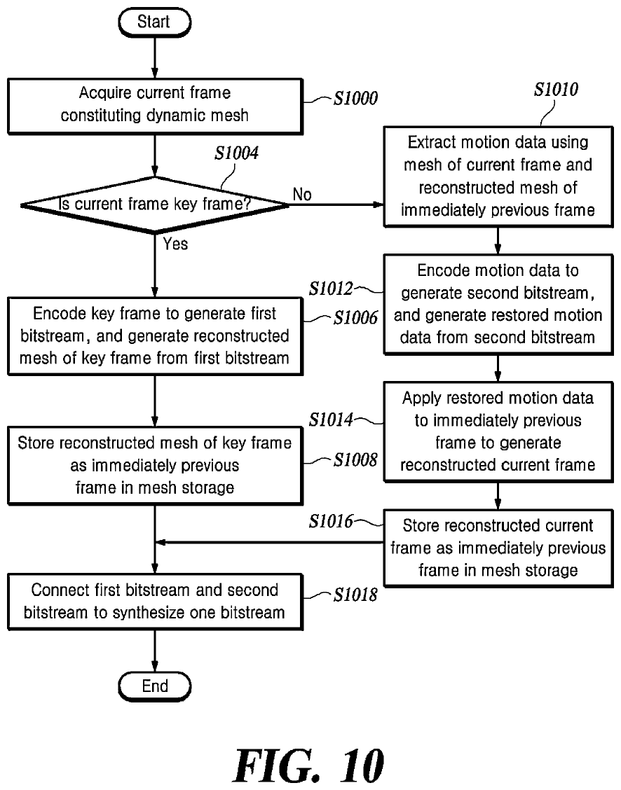

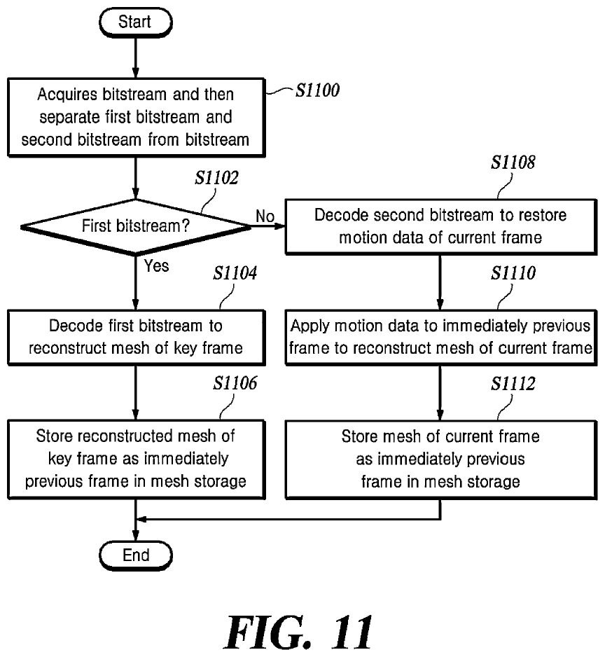

Hereinafter, a dynamic mesh encoding method and a dynamic mesh decoding method are described using the illustrations of FIGS. 10 and 11.

FIG. 10 is a flowchart illustrating a dynamic mesh encoding method according to an embodiment of the present disclosure.

The encoding apparatus acquires a current frame constituting a dynamic mesh (S1000).

The encoding apparatus checks whether or not the current frame is a preset key frame (S1004).

When the current frame is the key frame (Yes in S1004), the encoding apparatus performs the following steps.

The encoding apparatus encodes the key frame to generate the first bitstream and generates the reconstructed mesh of the key frame from the first bitstream (S1006). To encode the mesh, the encoding apparatus may use an existing mesh encoding method. Further, the encoding apparatus may reconstruct the mesh before generating a final bitstream related to the mesh by using a decoding method corresponding to the encoding method so that the reconstructed mesh can be referred to by the next frame.

The encoding apparatus stores the reconstructed mesh of the key frame as the immediately previous frame in the mesh storage (S1008). Later, the key frame stored in the mesh storage 104 can be used for encoding of the next frame.

When the current frame is not the key frame but one of non-key frames (No in S1004), the encoding apparatus performs the following steps.

The encoding apparatus extracts the motion data using the mesh of the current frame and the reconstructed mesh of the immediately previous frame (S1010). For example, the encoding apparatus may extract the motion data for each vertex of the mesh. As another example, the encoding apparatus may extract at least one piece of motion data for one face of the mesh. As another example, the encoding apparatus may extract the motion data on a per patch including a plurality of surfaces and vertices. Here, the motion data of vertices, faces, or patches may be three-dimensional motion vectors representing how the vertices, faces, or patches move.

The encoding apparatus encodes the motion data to generate a second bitstream, and generates the restored motion data from the second bitstream (S1012).

The encoding apparatus may generate at least one motion map by two-dimensionally mapping the motion vector, may down-sample the motion map and then may encode the down-sampled motion map using a video or image compression method to generate a second bitstream. Further, the encoding apparatus may generate the restored motion data from the second bitstream by applying the above-described steps inversely.

The encoding apparatus applies the restored motion data to the immediately previous frame to generate a reconstructed current frame (S1014). The encoding apparatus may apply the restored motion data to the immediately previous frame to compensate for the motion, to reconstruct the current frame.

The encoding apparatus stores the reconstructed current frame as the immediately previous frame in the mesh storage (S1016). Later, the current frame stored in the mesh storage 104 may be used for encoding of the next frame.

Finally, the encoding apparatus connects the first bitstream and the second bitstream to synthesize one bitstream (S1018). The encoding apparatus may store the synthesized bitstream or may transfer the synthesize bitstream to the decoding apparatus.

FIG. 11 is a flowchart illustrating a dynamic mesh decoding method according to an embodiment of the present disclosure.

The decoding apparatus acquires the bitstream and then separates the first bitstream and the second bitstream from the bitstream (S1100). Here, the first bitstream is a bitstream in which a preset key frame among a plurality of frames representing the dynamic mesh has been encoded. The second bitstream is a bitstream in which one of frames other than the key frame among the plurality of frames, i.e., non-key frames has been encoded. The decoding apparatus may use the header information of the bitstream to separate the bitstream.

The decoding apparatus checks whether the bitstream is the first bitstream (S1102) and performs the following steps when the bitstream is the first bitstream (Yes in S1102).

The decoding apparatus decodes the first bitstream to reconstruct the mesh of the key frame (S1104). The decoding apparatus may use a decoding method corresponding to the encoding method used by the encoding apparatus to decode the mesh.

The decoding apparatus stores the mesh of the key frame as the immediately previous frame in the mesh storage (S1106). Later, the key frame stored in the mesh storage 206 may be used for decoding the next frame.

When the bitstream is the second bitstream (No in S1102), the decoding apparatus performs the following steps.

The decoding apparatus decodes the second bitstream to restore the motion data of the current frame (S1108). As described above, the restored motion data may be a three-dimensional motion vector.

The decoding apparatus decodes the second bitstream to restore the motion map using a decoding method corresponding to the encoding method used in the dynamic mesh encoding apparatus. The decoding apparatus may up-sample the restored motion map and then may convert the up-sampled motion map into a motion vector.

The decoding apparatus applies the motion data to the immediately previous frame to reconstruct the mesh of the current frame (S1110). The decoding apparatus may apply the restored motion data to the immediately previous frame to compensate for the motion. The current frame is thereby reconstructed.

The decoding apparatus stores the mesh of the current frame as the immediately previous frame in the mesh storage (S1112). The current frame stored in the mesh storage 206 may later be used for decoding the next frame.

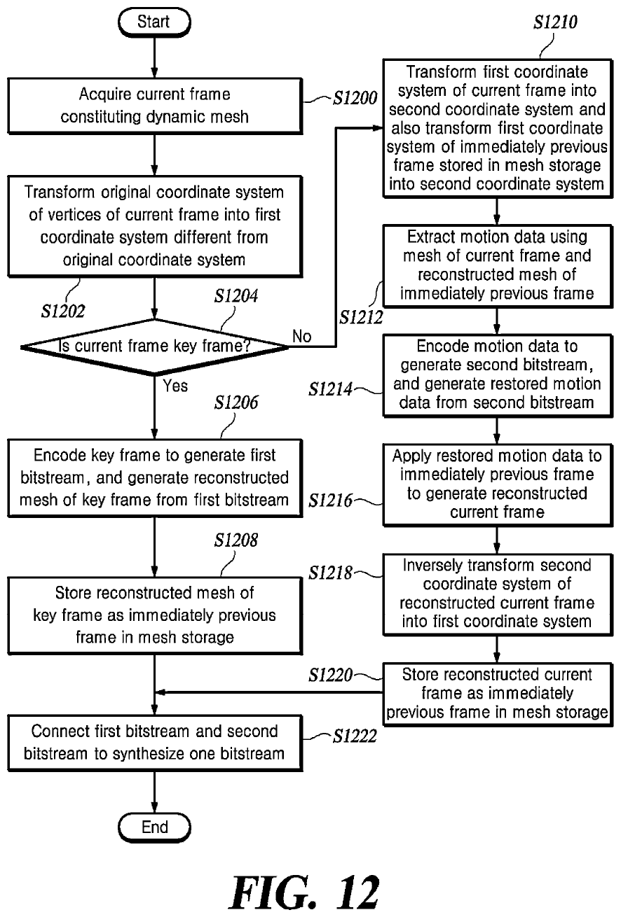

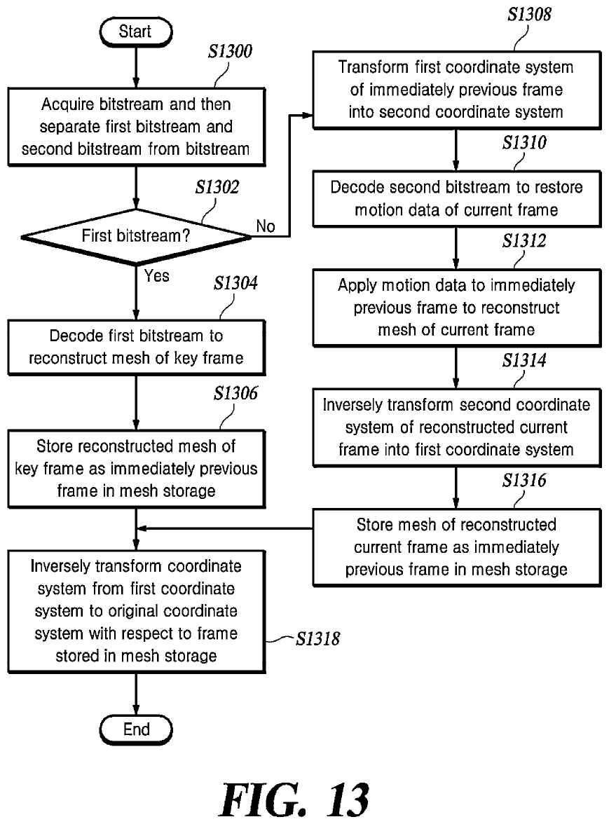

Hereinafter, a dynamic mesh encoding method and a dynamic mesh decoding method using two coordinate system transformations are described using the illustrations of FIGS. 12 and 13.

FIG. 12 is a flowchart illustrating a dynamic mesh encoding method according to another embodiment of the present disclosure.

The encoding apparatus acquires a current frame constituting the dynamic mesh (S1200).

The encoding apparatus transforms the original coordinate system of the vertices of the current frame into a first coordinate system different from the original coordinate system (S1202).

The encoding apparatus checks whether or not the current frame is a preset key frame (S1204).

When the current frame is the key frame (Yes in S1204), the encoding apparatus performs the following steps.

The encoding apparatus encodes the key frame to generate the first bitstream and generates the reconstructed mesh of the key frame from the first bitstream (S1206). To encode the mesh, the encoding apparatus may use an existing mesh encoding method. Further, the encoding apparatus may reconstruct the mesh before generating a final bitstream related to the mesh so that the reconstructed mesh can be referred to by the next frame.

The encoding apparatus stores the reconstructed mesh of the key frame as the immediately previous frame in the mesh storage (S1208). Later, the key frame stored in the mesh storage 104 can be used for encoding of the next frame.

When the current frame is not a key frame but instead is one of non-key frames (No in S1204), the encoding apparatus performs the following steps.

The encoding apparatus transforms the first coordinate system of the current frame into the second coordinate system and also transforms the first coordinate system of the immediately previous frame stored in the mesh storage into the second coordinate system (S1210).

The encoding apparatus extracts the motion data using the mesh of the current frame and the reconstructed mesh of the immediately previous frame (S1212). As described above, the motion data may be the three-dimensional motion vector.

The encoding apparatus encodes the motion data to generate a second bitstream and generates the restored motion data from the second bitstream (S1214).

The encoding apparatus may generate at least one motion map by two-dimensionally mapping the motion vector, may down-sample the motion map, and then may encode the down-sampled motion map using a video or image compression method to generate a second bitstream. Further, the encoding apparatus may generate the restored motion data from the second bitstream by applying the above-described steps inversely.

The encoding apparatus applies the restored motion data to the immediately previous frame, of which the coordinate system has been transformed, to generate a reconstructed current frame (S1216). The encoding apparatus may apply the restored motion data to the immediately previous frame to compensate for the motion. The current frame is thereby reconstructed.

The encoding apparatus inversely transforms the second coordinate system of the reconstructed current frame into the first coordinate system (S1218).

The encoding apparatus stores the reconstructed current frame as the immediately previous frame in the mesh storage (S1220). Later, the current frame stored in the mesh storage 104 may be used for encoding of the next frame.

Finally, the encoding apparatus connects the first bitstream and the second bitstream to synthesize one bitstream (S1222). The encoding apparatus may store the synthesized bitstream or may transmit the synthesized bitstream to a decoding apparatus.

FIG. 13 is a flowchart illustrating a dynamic mesh decoding method according to another embodiment of the present disclosure.

The decoding apparatus acquires the bitstream and then separates the first bitstream and the second bitstream from the bitstream (S1300). The decoding apparatus may use the header information of the bitstream to separate the bitstream.

The decoding apparatus checks whether the bitstream is the first bitstream (S1302) and, erforms the following steps when the bitstream is the first bitstream (Yes in S1302).

The decoding apparatus decodes the first bitstream to reconstruct the mesh of the key frame (S1304). The decoding apparatus may use a decoding method corresponding to the encoding method used by the encoding apparatus to decode the mesh.

The decoding apparatus stores the mesh of the key frame as the immediately previous frame in the mesh storage (S1306). The key frame stored in the mesh storage 206 may later be used for decoding the next frame.

When the bitstream is the second bitstream (No in S1302), the decoding apparatus performs the following steps.

The decoding apparatus transforms the first coordinate system of the immediately previous frame into the second coordinate system (S1308).

The decoding apparatus decodes the second bitstream to restore the motion data of the current frame (S1310). As described above, the restored motion data may be a three-dimensional motion vector.

The decoding apparatus decodes the second bitstream to restore the motion map using a decoding method corresponding to the encoding method used in the dynamic mesh encoding apparatus. The decoding apparatus may up-sample the restored motion map and then, may convert the up-sampled motion map into a motion vector.

The decoding apparatus applies the motion data to the immediately previous frame to reconstruct the mesh of the current frame (S1312). The decoding apparatus may apply the restored motion data to the immediately previous frame to compensate for the motion, to thereby reconstruct the current frame.

The decoding apparatus inversely transforms the second coordinate system of the reconstructed current frame into the first coordinate system (S1314).

The decoding apparatus stores the mesh of the current frame as the immediately previous frame in the mesh storage (S1316). The current frame stored in the mesh storage 206 may later be used for decoding the next frame.

Finally, the decoding apparatus inversely transforms the coordinate system from the first coordinate system to the original coordinate system with respect to the frame stored in the mesh storage (S1318).

Although the steps in the respective flowcharts are described to be sequentially performed, the steps merely instantiate the technical idea of some embodiments of the present disclosure. Therefore, a person having ordinary skill in the art to which this disclosure pertains could perform the steps by changing the sequences described in the respective drawings or by performing two or more of the steps in parallel. Hence, the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “. . . unit” or “. . . or” to strongly emphasize the possibility of their independent realization.

Meanwhile, various methods or functions described in some embodiments may be implemented as instructions stored in a non-transitory recording medium that can be read and executed by one or more processors. The non-transitory recording medium may include, for example, various types of recording devices in which data is stored in a form readable by a computer system. For example, the non-transitory recording medium may include storage media such as an erasable programmable read-only memory (EPROM), a flash drive, an optical drive, a magnetic hard drive, and/or a solid state drive (SSD) among others.

Although embodiments of the present disclosure have been described for illustrative purposes, those having ordinary skill in the art to which this disclosure pertains should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, those having ordinary skill in the art to which this disclosure pertains should understand that the scope of the present disclosure is not to be limited by the above explicitly described embodiments but by the claims and equivalents thereof.

### REFERENCE NUMERALS

102: Mesh encoder
106: Motion extractor
108: Motion encoder
110: Motion compensator
204: Mesh decoder
208: Motion decoder
210: Motion compensator

What is claimed is:

1. A decoding method for decoding a dynamic mesh, performed by a dynamic mesh decoding apparatus, the decoding method comprising:
acquiring a bitstream and then separating a first bitstream and a second bitstream from the bitstream, wherein a preset key frame among a plurality of frames representing the dynamic mesh is encoded in the first bitstream and one of the frames other than the key frame among the plurality of frames is encoded in the second bitstream; and
decoding the bitstream,
wherein, when the bitstream is the first bitstream, decoding the bitstream includes
reconstructing a mesh of the key frame by decoding the first bitstream, and
storing the mesh of the key frame as a immediately previous frame in a mesh storage, and
wherein, when the bitstream is the second bitstream, decoding the bitstream includes
restoring motion data of a current frame by decoding the second bitstream,
reconstructing a mesh of the current frame by applying the motion data to an immediately previous frame, and
storing the mesh of the current frame as the immediately previous frame in the mesh storage.

2. The decoding method of claim 1, wherein restoring the motion data includes:
restoring the motion data for each vertex of the mesh of the current frame.

3. The decoding method of claim 1, wherein restoring the motion data includes:
restoring at least one piece of motion data for one face of the mesh of the current frame.

4. The decoding method of claim 1, wherein restoring the motion data includes:
restoring a three-dimensional motion vector as the motion data.

5. The decoding method of claim 4, wherein restoring of the motion data includes:
restoring a motion map by decoding the second bitstream using a decoding method corresponding to an encoding method used in a dynamic mesh encoding apparatus;
up-sampling the restored motion map; and
converting the up-sampled motion map into a motion vector.

6. An encoding method for encoding a dynamic mesh, performed by a dynamic mesh encoding apparatus, the encoding method comprising:
acquiring a current frame constituting the dynamic mesh and checking whether the current frame is a preset key-frame; and
encoding the current frame,
wherein, when the current frame is the key frame, encoding the current frame includes
encoding the key frame to generate a first bitstream and generating a reconstructed mesh of the key frame from the first bitstream, and
storing the reconstructed mesh of the key frame as an immediately previous frame in a mesh storage, and
wherein, when the current frame is not the key frame, encoding the current frame includes
extracting motion data using a mesh of the current frame and the reconstructed mesh of the immediately previous frame,
generating a second bitstream by encoding the motion data and generating restored motion data from the second bitstream,
generating a reconstructed current frame by applying the restored motion data to the immediately previous frame, and
storing the reconstructed current frame as the immediately previous frame in the mesh storage.

7. The encoding method according to claim 6, further comprising:
synthesizing one bitstream by connecting the first bitstream and the second bitstream. includes:

8. The encoding method according to claim 6, wherein extracting the motion data extracting the motion data for each vertex of the mesh of the current frame.

9. The encoding method according to claim 6, wherein extracting the motion data includes:
extracting at least one piece of motion data for one face of the mesh of the current frame, wherein the at least one piece of motion data is extracted by interpolating motion data of vertices constituting the one face.

10. The encoding method according to claim 6, wherein extracting the motion data includes:
extracting a three-dimensional motion vector as the motion data.

11. The encoding method according to claim 10, wherein generating the restored motion data includes
generating at least one motion map by mapping the motion vector two-dimensionally;
down-sampling the motion map; and
generating the second bitstream by encoding the down-sampled motion map using a video or image compression method.

12. The encoding method according to claim 11, wherein generating the motion map includes:
projecting the motion vector onto x, y, and z axes to generate three motion maps.

13. A computer-readable recording medium storing a bitstream generated by a an encoding method for encoding a dynamic mesh, the encoding method comprising:
acquiring a current frame constituting the dynamic mesh and checking whether the current frame is a preset key-frame; and
encoding the current frame,
wherein, when the current frame is the key frame, encoding the current frame includes
encoding the key frame to generate a first bitstream and generating a reconstructed mesh of the key frame from the first bitstream, and
storing the reconstructed mesh of the key frame as an immediately previous frame in a mesh storage, and
wherein, when the current frame is not the key frame, encoding the current frame includes
extracting motion data using a mesh of the current frame and the reconstructed mesh of the immediately previous frame,
generating a second bitstream by encoding the motion data and generating restored motion data from the second bitstream,
generating a reconstructed current frame by applying the restored motion data to the immediately previous frame, and
storing the reconstructed current frame as the immediately previous frame in the mesh storage.
